(19) United States
(12) Patent Application Publication
(10) Pub. No.: US 2011/0276403 A1
(43) Pub. Date: Nov. 10, 2011

(54) HANDOVER DECISION PROCEDURE IN A MOBILE COMMUNICATIONS SYSTEM

(75) Inventor: Preetida Vinayakray-Jani, Ahmedabad (IN)

(73) Assignee: NOKIA CORPORATION, Espoo (FI)

(21) Appl. No.: 13/121,316

(22) PCT Filed: Sep. 24, 2009
(86) PCT No.: PCT/IB09/06959

§ 371 Date: May 24, 2011

Related U.S. Application Data
(60) Provisional application No. 61/136,733, filed on Sep. 29, 2008.

(51) Int. Cl. G06Q 30/00

(52) U.S. Cl. 705/14.64; 705/14.4

(57) ABSTRACT

In an advertisement based movement detection a mobile node adjusts its advertisement waiting period when it receives an advertisement from a serving access entity of the mobile node and an advertisement from another access entity. By adjusting the waiting period a timely handover may be performed.

### RELATED APPLICATION

This application claims priority to U.S. Provisional Application No. 61/136,733 which is incorporated herein by reference in its entirety.

### TECHNICAL FIELD

The present invention relates to a handover in a mobile communications system, and more particularly to a handover decision in an overlapping coverage area, the handover decision relating to a selection of an access entity, i.e. whether or not to trigger a handover.

### BACKGROUND

Evolvement of communication technologies has introduced a diverse range of different access technologies, wireless and wired, moving networks and multimode user terminals that enable access to services over different access technologies. Despite of the heterogeneous networks end users want to access their services anytime with freedom of movement and uninterrupted access. This requires seamless handover—within a network, between homogenous networks (i.e. networks using same access technology) and between heterogeneous networks.

U.S. Pat. No. 7,362,731, having the same applicant and inventor as the present invention and incorporated as a reference herein, discloses one solution to optimize the handover decision procedure. The solution is based on movement detection utilizing agent or router advertisements and two different time intervals: a waiting period and a solicitation waiting period. First, a mobile node waits for a waiting period, starting from a first reference moment, to see if a new advertisement is received from the serving network access entity within the waiting period. If this is the case, the mobile node remains connected to the serving network access entity, i.e. movement is not detected and no handover performed. If a new advertisement from the serving access entity does not arrive within the waiting period, the mobile node issues a router solicitation message and starts to measure a solicitation waiting period from a second reference moment. If a response, e.g. a fast router advertisement, arrives from the serving network access entity within the solicitation waiting period, the mobile node decides that it has not yet moved away from the coverage area of the serving network access entity and no handover is performed. However, if the response does not arrive within the solicitation waiting period, movement is detected and a handover triggered.

Although the above provides rather seamless and non-oscillating handover, very delay sensitive interactive real-time services, such as voice over Internet and media streaming, have stringent performance requirements on end-to-end delay and packet loss thereby tightening requirements to procedures supporting mobility, such as the handover procedure.

### SUMMARY

The invention relates to a method, an apparatus and an article of manufacture that are defined in the independent claims. Preferred embodiments of the invention are disclosed in the dependent claims.

In a general aspect, implementations may include adjusting a waiting period in response to detecting that within the waiting period advertisements from a serving node and a new node have been received. This provides a further optimization of a handover decision procedure in an overlapping region and facilitates to achieve the stringent performance requirements.

### BRIEF DESCRIPTION OF THE DRAWINGS

In the different embodiments will be described with reference to the attached drawings, in which

FIG. 1 illustrates a communication environment;

FIG. 2 is a flow chart illustrating a functionality according to an embodiment;

FIG. 3 is a signaling chart illustrating signaling of an example situation according to an embodiment; and

FIG. 4 is a block diagram of an apparatus according to an embodiment.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The present invention is applicable to any apparatus that supports a handover procedure triggered by an advertisement-based movement detection in a communication environment supporting mobility. The communication environment includes access technologies supporting mobility of an end user terminal, and/or access technologies supporting mobility of an access entity providing to an end user terminal (fixed or mobile) access to communication services, and/or access technologies supporting mobility of another access entity. A variety of system configurations applying a variety of communication technologies may be used separately or in combinations to implement the embodiments. The protocols used and the specifications of communication environment (including system, network nodes and user terminals), especially in wireless communication, develop rapidly. Such development may require modifications to an embodiment. Therefore all words and expressions used should be interpreted broadly, as they are intended merely to illustrate, not to restrict, the embodiments.

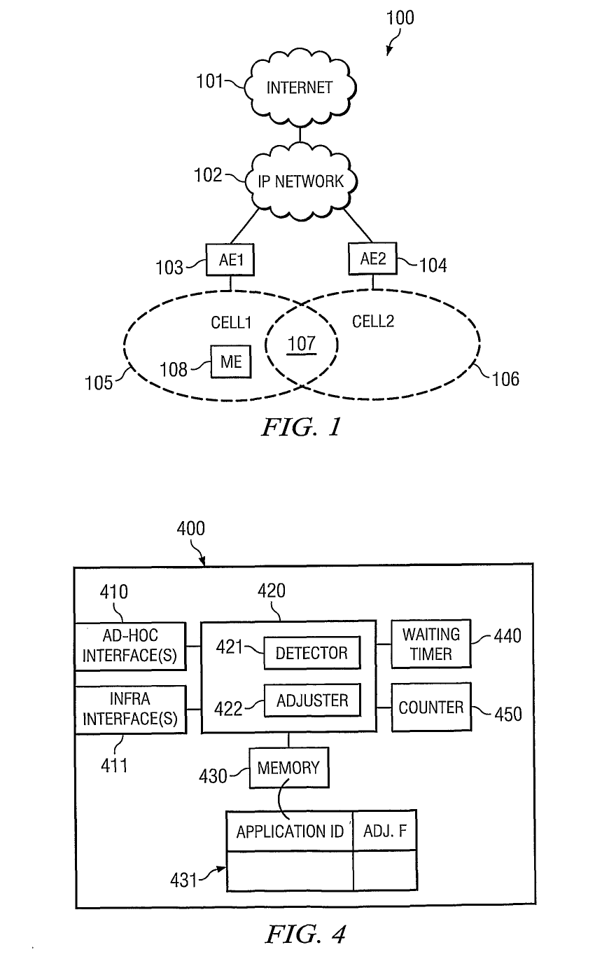

A general architecture of a communication environment is illustrated in FIG. 1. FIG. 1 is a simplified communication environment only showing some elements and functional entities providing access to Internet to a mobile entity roaming outside its home network without restricting the embodiment to roaming mobile entities, however. Further, it is apparent to a person skilled in the art that the environment also comprises other functions and structures.

The environment 100 comprises several subnetworks (not illustrated in FIG. 1) within an IP network 102, such as a core network of an operator, the IP network providing access to Internet 101 and its services. The IP network is accessed via access entities (AE) 103, 104 in subnetworks, the access entities 103, 104 offering connectivity at an IP layer. An access entity may control one or more access points (not illustrated in FIG. 1), each access point having a service area called a cell 105, 106 and offering link layer connectivity. Thus, a service area of an access entity comprises one or more cells. Typically two adjacent service areas of two adjacent access entities comprise an overlapping region 107 in which a service is accessible via two or more access entities, not only via one access entity.

A subnetwork containing one or more access entities 103, 104 may be based on one of the following access technologies including a wireless metropolitan area network (WMAN), such as an WiMax; a wireless local area network (WLAN), such as Wi-Fi; a mobile network, such as a mobile ad hoc network (MANET); a mobile broadband wireless access (MBWA) or Mobile-fi; a wireless personal area network (WPAN), such as those based on IrDA, Bluetooth, ultra-wideband (UWB), Z-Wave and ZigBee; a cable, such as an ethernet; a digital subscriber line (DSL); different kinds of mobile communications system based network, such as UMTS, WCDMA, GSM, GPRS, 3GPP, LTE, 4G; a wired circuit switched network, etc. In other words, it can be any kind of a network providing access to an apparatus supporting the access technology.

An access entity 103, 104 is an apparatus providing connectivity between a mobile entity (ME) 108 and network infrastructure. It provides and controls access to IP services and the Internet, and is preferably configured to broadcast periodic router advertisements. Examples of access entities 103, 104 include access routers (ARs) of WLANs, packet data support nodes (PDSN, also called packet data serving nodes) of 3GPP networks, gateway GPRS support nodes (GGSN) of 3GPP networks, mobile routers when they are acting as gateways in mobile networks, and a border router of MANET.

A mobile entity 108 may be any computing apparatus which is able to connect to a subnetwork. It may be a single-mode, dual-mode or multimode apparatus supporting one, two or multiple access technologies, correspondingly. The mobile entity 108 may be a mobile node (MN) in a non-mobile (fixed) network or a mobile network node (MNN) in a mobile network, the MNN being either a fixed node or a mobile node. Thus, the mobile entity 108 may be an end user terminal, or corresponding end host, which allows a user to interact with a communications system and is connectable to the network wirelessly or via a fixed connection. Examples of the user terminal include a personal computer, a game console, a laptop (a notebook), a personal digital assistant, a mobile station (mobile phone), a handset, and a line telephone. Further, the mobile entity may be a mobile router (MR) when it is requesting access services via an access entity.

If the mobile entity 108 is roaming outside its home network, i.e. its current point of attachment to the IP network is in a subnetwork that is not its home network, the mobile entity 108 may use a protocol developed by the Internet Engineering Task Force (IETF) to provide continuous connection to Internet when moving from an access entity to another. Examples of such protocols include Mobile IP (either MIPv6.0 as described in RFC3775 by D. Johnson, C. Perkins and J. Arkko, dated June 2004 or MIPv4.0 described in RFC2002 by C. Perkins, dated October 1996) or network mobility (NEMO, described in RFC3963 by V. Devarapalli, R. Wakikawa, A. Petrescu, and P. Thubert, dated January 2005), all incorporated as a reference herein. In principle, a home agent (not illustrated in FIG. 1) of the mobile entity captures all IP packets sent to the home address of the mobile entity, and forwards them to the current IP address of the mobile entity, called a care-of address. (In case of a nested network, the home agent captures packets send to entities below a root mobile entity of the nested network.) When the mobile entity moves, it registers its current care-of address with the home agent so that the home agent can forward the packets to the mobile entity. Typically each access entity multicasts agent advertisements periodically, whereby the mobile entities may discover their neighboring access entities, and thus also the care-of addresses available, simply by listening for the agent advertisements. However, if a mobile entity wishes to obtain a care-of address immediately without waiting for a periodic agent advertisement, it may also broadcast or multicast a so-called agent solicitation message. The agent advertisements and agent solicitations are also commonly termed router advertisements and router solicitations, respectively.

In the following it is assumed that a mobile entity enters to an overlapping region of two or more access entities. During a handover between access entities the mobile entity registers its new location with the home agent, or with a local mobility gateway if micro-mobility is utilized. It should be appreciated that a handover as used herein covers situations in which, in addition to an access point changing to another access point, also a serving access entity is changed to another access entity, a situation in which more than one access entity is connected to an access point and the access entity changes although the access point remains the same, and a situation in which the access point changes but the serving access entity remains the same.

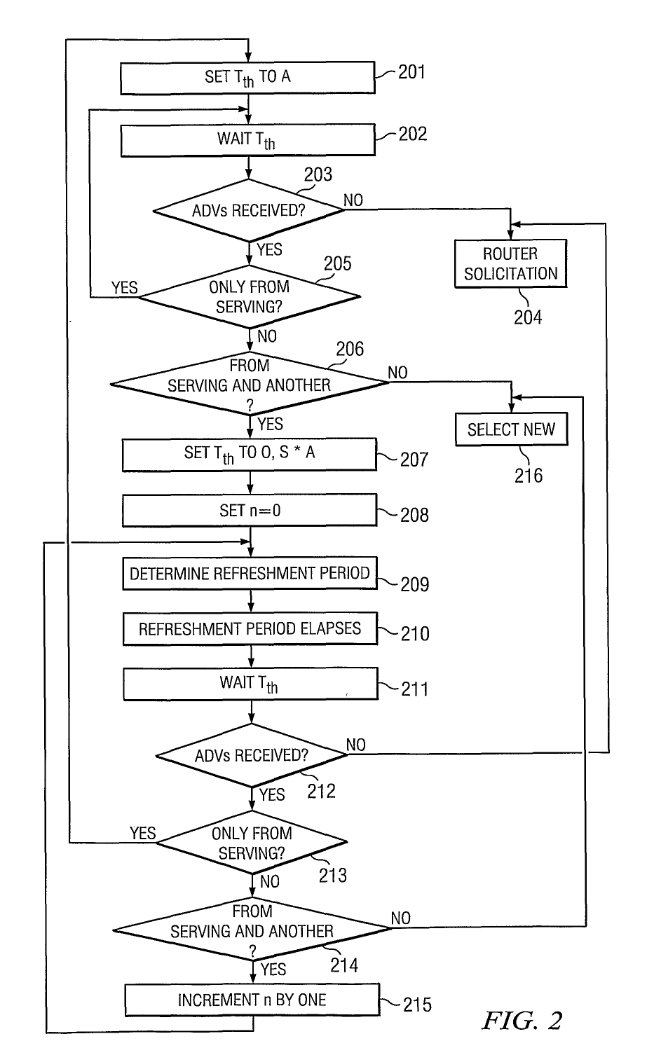

FIG. 2 is a flow chart illustrating a functionality of a mobile entity according to an embodiment. In FIG. 2 it is assumed that fast router feature is supported, a mobile entity has a serving access entity, and the mobile entity initiates a movement detection by setting (step 201) a waiting period Tth for advertisements to be A. (The waiting period is also called a threshold period.) Although it is irrelevant how the value A is determined, some examples are given. The value A of the waiting period may be selected to be an advertisement interval of the serving entity Tadv, a fixed value, a value between a maximum solicitation period (i.e. a standardized advertisement period) and a minimum solicitation period, equal to the maximum solicitation period, equal to the minimum solicitation period and/or it may depend on the application using the connection or the quality of service requirements of the connection. The advertisement interval Tadv may be received in the advertisement or it may be a measured interval between two consecutive advertisements from the serving access entity. Although the value of the waiting period is typically selected to be between zero and Tadv, it may also be greater than Tadv (i.e. greater than the mean period between the router advertisements received).

When the value of the waiting period is set to A, the mobile entity waits (step 202) the waiting period, and after that checks (step 203) whether any advertisements (ADV) arrived (i.e. were received). If no advertisement was received, the mobile entity issues (step 204) a router solicitation message, and continues as disclosed in U.S. Pat. No. 7,362,731. In other words, it waits a solicitation waiting period for responses and after that decides whether or not to trigger a handover. If a response, e.g. a fast router advertisement, arrives from the serving network access entity within the solicitation waiting period, the mobile entity decides that it has not yet moved away from the coverage area of the serving network access entity, and returns to step 202. However, if the response from the serving network access entity does not arrive within the solicitation waiting period, movement is detected, and a handover triggered.

If one or more advertisements arrived (step 203), the mobile entity then checks (step 205), whether only an advertisement from the serving access entity was received. If the serving access entity is the only one from which an advertisement was received, the mobile entity is not in an overlapping region and waits (step 202) another time period A for advertisements.

If an advertisement was received from the serving access entity and in addition one or more advertisements from one or more other access entities were received (step 206), the mobile entity sets (step 207) the waiting period value Tth to be half of A and sets, in step 208, the amount of successive reduced waiting periods, i.e. n, to be zero. In the embodiment, the amount of successive reduced waiting periods is used for determining a length of a refreshment period (step 209). The waiting period Tth starts right after the refreshment period has elapsed (210). In the embodiment, the length of a refreshment period depends on n so that it is n ms. In other words, when n is zero, the refreshment period is zero, when n is 2, the refreshment period is 2 ms, etc. This has the effect that it is possible to take into account that a mobile entity is not moving for some time in the overlapping area. It should be appreciated that any other kind of dependency may be used, or the refreshment period may be a constant.

When the refreshment period has been elapsed (210), the mobile entity waits (step 211) the reduced time period Tth for advertisements. When the time period has lapsed, the mobile entity checks (step 212) whether any advertisements (ADV) were received. If no advertisement was received, the mobile entity issues (step 204) a router solicitation message to the serving network access entity, and continues as described above. In other words, if a response arrives from the serving network access entity within the solicitation waiting period, the mobile entity returns to step 202. However, if the response from the serving network access entity does not arrive within the solicitation waiting period, movement is detected, and a handover triggered.

If one or more advertisements arrived (step 212) during the reduced waiting period, the mobile entity then checks (step 213), whether an advertisement only from the serving access entity was received. If an advertisement was received only from the serving access entity, the mobile entity is not anymore in an overlapping region but in a service area of the currently serving access entity, and the waiting period Tth is again set (step 201) to the original value A, and the process continues from the step 202. Thus, no handover is performed.

If an advertisement was received from the serving access entity and one or more advertisements from one or more other access entities, correspondingly, were received (step 214), the mobile entity increments in step 215 the amount of successive reduced waiting periods n by one, determines (step 209) the refreshment period, waits (step 210) it to elapse and then again waits (step 211) the reduced time period Tth for advertisements.

If during a waiting period (shortened or the original) one or more advertisements were received but none of them from the serving access entity (step 206 or step 214), a handover is triggered in step 216 by a selection of a new serving access entity.

In another embodiment, if within the adjusted shorter waiting period routing advertisement are received from the serving access entity and from another access entity (step 214), the waiting period Tth is readjusted by setting (step 201) it back to the original value A, and the process continues from the step 202. In another embodiment, some other value instead of the original value A may be used. Thus, in an overlapping region the waiting time is first shortened, then set to be a longer one, next time a shorter one, a longer one again, i.e. the waiting period oscillates as long as the mobile entity is in the overlapping region and receives service from the serving access entity.

In the above embodiment the adjusted shorter waiting period was half of the original waiting period. It should be understood, that it is only an example and other ways to adjust the waiting period to be shorter may be used. However, the shorter waiting period is preferably between 0.5 A to A or equals to one of the endpoint, when A is the waiting period used in a non-overlapping region.

In another embodiment, the amount of successive reduced waiting periods is not taken into account, and steps 208 and 215 are omitted, and the refreshment period may be a constant (i.e. step 209 may also be omitted). In a further embodiment, the amount of successive reduced waiting periods are calculated but no refreshment periods are used (i.e. steps 209 and 210). Instead, in the embodiment, after the amount of successive reduced waiting periods is incremented, it is compared to a predetermined value, and on the basis of the comparison the value of the waiting period may be maintained or readjusted (to original one, to be smaller, or to be something between the original one and the reduced one).

As can be seen from the above, the embodiments do not affect to the actual handover procedure but they affect to the decision whether or not (and when) to trigger the handover.

Let us imagine an example situation: a user is sitting in a bench, waiting for a bus and using the Internet via his user terminal connected to a hot spot WLAN radio. Then the bus arrives and the user walks to the bus while still having an Internet page open and the hot spot connectivity goes down but the user terminal hands the connection over to an ad hoc mobile network to maintain the active session. A mobile router providing the ad hoc mobile network is connected to the Internet via a WiMax network when the user enters the bus but when the user leaves the bus the ad hoc mobile network is connected to the Internet via a 3GGP network.

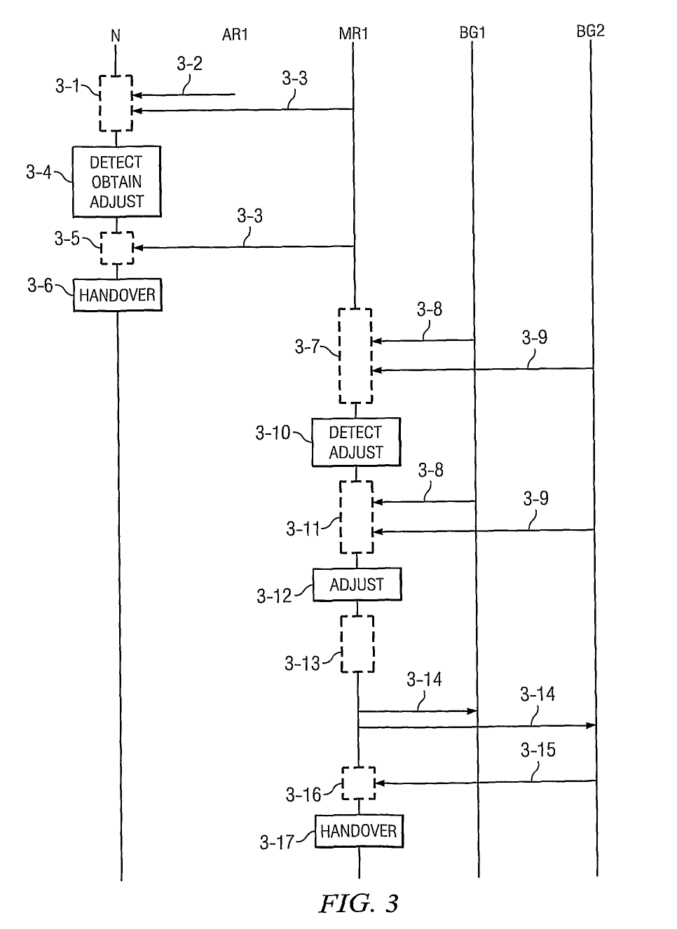

FIG. 3 is a flow chart illustrating a signaling according to an embodiment in the above example situation. Referring to FIG. 3, the user terminal UT is served by an access router AR1 and has set its waiting period to be value A. When the user walks to the bus, during the waiting period A (point 3-1), the node N receives two advertisements 3-2, and 3-3, one of them being from access router AR1 and another from a mobile router MR 1 advertising the ad hoc network in the bus.

In response to the two advertisement messages the user terminal detects in point 3-4 that it is in an overlapping region where service can be obtained via two or more access entities. In the embodiment it is assumed that the user terminal is configured, in response to the detection, to obtain an adjustment factor from a memory, the value of the adjustment factor depending on an application for which the connection is established. In other embodiments, the value of the adjustment factor may depend in addition to, or instead of, on the amount of received router advertisements during one waiting period and/or on the quality of service negotiated for the connection.

Therefore the user terminal obtains from its memory an adjustment factor for the Internet browsing application and adjusts the waiting period in point 3-4 to value B by multiplying A with the adjustment factor. In another embodiment the adjustment is performed by subtracting the adjustment factor from A.

Then the user terminal waits (point 3-5) a time period B for advertisements. This time an advertisement 3-3 arrived only from the mobile router, and the user terminal detects that it is not anymore in an overlapping region and not in the service area of the AR1 and triggers a handover in point 3-6. The end result of the handover is that the mobile router will be the serving access entity and the waiting period is initialized/set/adjusted to be A. After the handover the serving access entity is the mobile router. Further, to the end of this illustrated example situation the user stays in the bus, the user terminal does not move in respect to the ad hoc mobile network and the user terminals receives advertisements only from the mobile router. These subsequent waiting periods and received advertisements are not illustrated or described here.

Further, subsequent waiting periods of the mobile router in a non-overlapping area and corresponding router advertisements are not illustrated in FIG. 3. However, when the user has traveled in the bus some time, the bus (and mobile router) enters an overlapping area. The mobile router in the bus detects it because it receives during a waiting period (point 3-7) router advertisements 3-8, 3-9 from both a serving border router BR1 and another border router BR2. The mobile router in the embodiment is hardcoded, in response to an advertisement from the serving border router and the other border router, to adjust the waiting period step by step by monitoring intervals between subsequent router advertisements from the same border router. Further, the mobile router in the embodiment is configured to store temporarily the addresses of those non-serving border routers whose advertisement it received within the previous waiting period. This has the effect that a new serving access node is found a little bit earlier, as will be evident from the below.

When the mobile router detects, in point 3-10, for a first time that an overlapping region has been entered, it adjusts in point 3-10 the waiting period my multiplying the original waiting period with 0.75. In this example during the once adjusted waiting period (point 3-11) router advertisements 3-8, 3-9 are received from BR1 and BR2. Since in the example the time interval between two router advertisements from the other border router BR2 was smaller than the time interval between two router advertisements from the serving border router BR1 and since the latter increased to be 1.2 of the previous interval, the mobile router further adjusts in point 3-12 the waiting period by multiplying the once adjusted waiting period with 0.75. It should be appreciated that other interval-related rules than the above may be used.

In the example, no advertisements are received within the twice adjusted waiting period (point 3-12). Therefore the mobile router sends u router solicitation messages 3-14 to those border routers whose addresses it received in point 3-11. This time a response 3-15 only from BR2 arrived within the router solicitation waiting period (point 3-16) and therefore a handover to BR2 is triggered in point 3-17. If a response from BR1 would have arrived within the router solicitation waiting period, the mobile router would have decided that it is still on the coverage area of the BR1 and no handover would have been triggered, and the waiting period would have been set to be the original one (meaning returning to point 3-7). In embodiments in which the mobile router is not configured to store temporarily the addresses, a router solicitation message 3-14 is sent only to the serving border router, and if no response is received from the serving border router within the router solicitation waiting period, a selection of new serving border router is initiated (i.e. a handover triggered).

Although the embodiments have been described above assuming that a mobile entity is connected to one access entity at a time. However, a mobile entity may be connected to two or more mobile routers, for example, at a time. In the situation, the mobile node may be configured to detect entering an overlapping zone if an advertisement is received from an access entity to which the mobile entity is not connected to. Further, the access entities to which the mobile entity is connected to may have their own waiting periods, which may then be adjusted separately, for example adjusting all waiting periods, if the new access entity belongs to a new network and adjusting the waiting period of the access entity that belongs to the same network as the new access entity. Other adjustment possibilities include but are not limited to: adjust waiting periods simultaneously and similarly but the outcome is still different adjusted waiting periods, and adjusting the waiting periods to be equal to each other, at least for a while.

The steps/points, signaling messages and related functions described above in FIGS. 2 and 3 are in no absolute chronological order, and some of the steps/points may be performed simultaneously or in an order differing from the given one. For example, instead of router advertisements, access point advertisement may be received as access entity advertisements and the information in them may be used to detect that on overlapping zone has been entered. Other functions can also be executed between the steps/points or within the steps/points and other signaling messages sent between the illustrated messages. For example, the original waiting periods and solicitation waiting periods may have their own refreshment periods or reference moments. Some of the steps/points or part of the steps/points can also be left out or replaced by a corresponding step/point or part of the step/point. For example, if the fast router feature is not supported, unsolicitated router message, i.e. a broadcast or multicast message, is sent to all possible access entities instead of the unicast router solicitation message.

FIG. 4 is a schematic presentation of an apparatus according to an embodiment. The apparatus may be a mobile node or a mobile router. Although the apparatus has been depicted as one entity, different units, modules and memory may be implemented in one or more physical or logical entities. It should be appreciated that the apparatus may comprise other units that are not illustrated herein. The apparatus or a unit of the apparatus implementing an embodiment may be configured as a computer or a microprocessor, such as single-chip computer element, including at least a memory for providing storage area used for arithmetic operation and an operation processor for executing the arithmetic operation.

The apparatus 400 may generally include a processor, controller, control unit or the like 420 connected to a memory 430 and to various interfaces of the apparatus. Generally the processor is a central processing unit, but the processor may be an additional operation processor. The processor may comprise a computer processor, application-specific integrated circuit (ASIC), field-programmable gate array (FPGA), and/or other hardware components that have been programmed in such a way to carry out one or more functions of an embodiment. In the illustrated example the apparatus is an ad-hoc apparatus (either a mobile router or a mobile network node), in which case the interfaces of the apparatus may be divided into two classes: interfaces for adhoc networks 410 and interfaces for the network infrastructure 411. However, in another embodiment, the apparatus may be provided with one interface only, through which the apparatus communicates with the serving access controllers. Preferably the apparatus comprises a separate interface for each communication technology the apparatus supports. An interface provides a transmitter and/or a receiver or a corresponding means for receiving and/or transmitting data, content, messages including the above described advertisements, responses and solicitation messages.

The processor 420 further controls timers, such as a waiting timer 440 measuring the waiting periods. Other timers, not shown in FIG. 4, may include a solicitation waiting timer measuring the solicitation waiting periods and a refreshment timer measuring the refreshment periods.

In the illustrated embodiment, the apparatus further comprises a counter 450 for counting the number of successive adjusted waiting periods. It should be appreciated that embodiments not having the counter exist.

The apparatus 400 is configured to dynamically adjust waiting period in an overlapping region. For this purpose, the apparatus comprises a detector unit 421 for detecting that the apparatus is in an overlapping region or has entered it in response that within a waiting period advertisements from a serving access entity and another entity has been received, an adjuster unit 422 for adjusting the waiting period, i.e. to change the value the waiting timer 440 measures. Examples of functionalities of the detector unit and the adjuster unit are described above. The units may be software and/or software-hardware and/or firmware components (recorded indelibly on a medium such as read-only-memory or embodied in hard-wired computer circuitry).

The memory 430 may include volatile and/or non-volatile memory and typically stores content, data, or the like. For example, the memory 430 may store computer program code such as software applications (for example for the detector unit and/or for the adjuster unit) or operating systems, information, data, content, or the like for the processor 420 to perform steps associated with operation of the apparatus in accordance with embodiments. In the illustrated embodiment, the memory 430 stores application-specific adjustment factors with which the waiting period is adjusted in response to detecting the overlapping region. The memory may be, for example, random access memory (RAM), read only memory (ROM) flash memory, erasable-programmable read only memory (EPROM), a hard drive, or other fixed data memory or other computer-readable storage device. Further, the memory, or part of it, may be removable memory detachably connected to the apparatus.

The techniques described herein may be implemented by various means so that an apparatus implementing one or more functions of a corresponding mobile entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

As can be seen from the above embodiments provide a consistent access entity switching algorithm with dynamically adjustable waiting period that ensure a timely handover and improve the performance by ensuring that the handover decision is made early enough but handover oscillation is still avoided. Although during the dynamically shortened waiting period radio resources are used more than during a longer waiting period, an advantage is that radio resources are used more only in an overlapping region where it facilitates a seamless handover, and thereby shortens the latency and supports better real-time applications. Further, the dynamically adjustable waiting period will lower the number of handovers, and thereby improve the performance of higher layer protocols, like TCP, in overlapping regions, and yet guarantee that the mobile entity remains connected. Also, when fast router feature is not supported and if the mobile node misses advertisements, the dynamically adjusted waiting period causes the mobile node to broadcast unsolicited router message faster. Since all access entities receiving the message will respond to the message with broadcast advertisement, also other mobile nodes being in the neighborhood, i.e. in the same overlapping zone, receive the advertisements. This helps the other mobile nodes to update their cache and timely detect their migration.

It will be obvious to a person skilled in the art that, as the technology advances, the inventive concept can be implemented in various ways. The invention and its embodiments are not limited to the examples described above but may vary within the scope of the claims.

1.-22. (canceled)

23. A method comprising:
detecting that during a waiting period an advertisement from a serving access entity and an advertisement from another access entity have been received; and
adjusting the waiting period in response to the detecting.

24. The method of claim 23, further comprising:
readjusting the waiting period in response to receiving during the adjusted waiting period an advertisement from the serving entity.

25. The method of claim 23, further comprising:
readjusting the waiting period if within the adjusted waiting period an advertisement from the serving entity and no advertisement from the other access entity is received.

26. The method of claim 23, further comprising:
noticing that the waiting period during which an advertisement from a serving access entity and an advertisement from another access entity have been received is an adjusted waiting period; and
skipping, in response to the noticing, the adjusting.

27. The method of claim 23 wherein the waiting period is adjusted by multiplying the waiting period with a factor that equals to 0.5.

28. The method of claim 23 wherein the waiting period is adjusted by multiplying the waiting period with a factor that is between 0.5 and 1.0.

29. An apparatus comprising:
a receiver configured to receive access entity advertisements;
a waiting timer configured to measure a waiting period;
a detector, operable coupled to the receiver and the waiting timer, the detector being configured to detect an event indicating an overlapping region in response to receiving within a waiting period an access entity advertisement from a serving access entity and an access entity advertisement from another access entity; and
an adjuster, operable coupled to the detector and configured to adjust the waiting period in response to the detector detecting the occurrence of the event.

30. The apparatus of claim 29, wherein the adjuster is further configured to readjust the waiting period in response to the receiver receiving during the adjusted waiting period an advertisement from the serving entity.

31. The apparatus of claim 29, wherein the adjuster is further configured to readjust the waiting period in response to the receiver receiving within the adjusted waiting period an advertisement from the serving entity and no advertisement from the other access entity.

32. The apparatus of claim 29, wherein the adjuster is further configured not to adjust an already adjusted waiting period in response to the receiver receiving an advertisement from a serving access entity and an advertisement from another access entity within the adjusted waiting period.

33. The apparatus of claim 29, further comprising a counter configured to count a number of successive adjusted waiting periods during which an advertisement from a serving access entity and an advertisement from another access entity is received, wherein
the waiting timer is configured to be responsive to the counter in such a way that a refreshment time after which the waiting time starts depends on the number.

34. The apparatus of claim 29, the apparatus being one of a group comprising a mobile node for a non-mobile network, a mobile network node for a mobile network, a fixed node for a mobile network and a mobile router.

35. An article of manufacture, comprising a computer readable medium and embodying program instructions thereon executable by a computer operably coupled to a memory which, when executed by the computer, carry out the functions of:
detecting that during a waiting period an advertisement from a serving access entity and an advertisement from another access entity have been received; and
adjusting the waiting period in response to the detecting.

36. The article of manufacture of claim 35, further comprising instructions which, when executed by the computer, carry out the function of readjusting the waiting period in response to receiving during the adjusted waiting period an advertisement from the serving entity.

37. The article of manufacture of claim 35 further comprising instructions which, when executed by the computer, carry out the function of readjusting the waiting period if within the adjusted waiting period an advertisement from the serving entity and no advertisement from the other access entity is received.

38. The article of manufacture of claim 35, further comprising instructions which, when executed by the computer, carry out the functions of:
noticing that the waiting period during which an advertisement from a serving access entity and an advertisement from another access entity have been received is an adjusted waiting period; and
skipping, in response to the noticing, the adjusting.

39. An apparatus comprising:
receiving means for receiving access entity advertisements;
measuring means for measuring a waiting period;
detecting means, operable coupled to the receiving means and the measuring means, for detecting an event indicating an overlapping region in response to receiving within a waiting period an access entity advertisement from a serving access entity and an access entity advertisement from another access entity; and
adjusting means, operable coupled to the detecting means, for adjusting the waiting period in response to the detecting means detecting the occurrence of the event.

40. The apparatus of claim 39, wherein the adjusting means are further configured to readjust the waiting period in response to the receiving means receiving during the adjusted waiting period an advertisement from the serving entity.

41. The apparatus of claim 39 wherein the adjusting means are further configured to readjust the waiting period in response to the receiving means receiving within the adjusted waiting period an advertisement from the serving entity and no advertisement from the other access entity.

42. The apparatus of claim 39, wherein the adjusting means are further configured not to adjust an already adjusted waiting period in response to the receiving means receiving an advertisement from a serving access entity and an advertisement from another access entity within the adjusted waiting period.

43. The apparatus of claim 39, further comprising counting means for counting a number of successive adjusted waiting periods during which an advertisement from a serving access entity and an advertisement from another access entity is received, wherein
the measuring means are configured to be responsive to the counting means in such a way that a refreshment time after which the waiting time starts depends on the number.

44. The apparatus of claim 39, the apparatus being one of a group comprising a mobile node for a non-mobile network, a mobile network node for a mobile network, a fixed node for a mobile network and a mobile router.
